(19) United States
(12) Patent Application Publication
(10) Pub. No.: US 2016/0035320 A1
(43) Pub. Date: Feb. 4, 2016

(54) TIMING CONTROLLER, DISPLAY DEVICE INCLUDING THE SAME, AND METHOD FOR DRIVING THE SAME

(71) Applicant: Samsung Display Co., Ltd., Yongin-City (KR)

(72) Inventors: Young Soo YOON, Seoul (KR); Ah Reum KIM, Hwaseong-si (KR)

(21) Appl. No.: 14/547,447

(22) Filed: Nov. 19, 2014

(30) Foreign Application Priority Data
Aug. 1, 2014 (KR) 10-2014-0099106

(51) Int. Cl. G09G 5/18; G09G 5/10; G06F 3/01

(52) U.S. Cl. CPC G09G 5/18; G06F 3/013; G09G 5/10

(57) ABSTRACT

A timing controller for a display device and a method for driving the same, wherein the timing controller comprises a first controller providing a driving frequency change signal for changing a first driving frequency to a second driving frequency that is different from the first driving frequency and a second controller receiving the driving frequency change signal and generating a scan start signal corresponding to the second driving frequency, the second controller outputting a changed scan start signal in response to sensing a blink of an eye of a user.

### CLAIM OF PRIORITY

This application makes reference to, incorporates the same herein, and claims all benefits accruing under 35 U.S.C §119 from an application earlier filed in the Korean Industrial Property Office on 1 Aug. 2014, and there duly assigned Serial No. 10-2014-0099106 by that Office.

### BACKGROUND OF THE INVENTION

1. Field of the Invention

The present invention relates to a timing controller, a display device including the same, and a method for driving the same.

2. Description of the Related Art

With the development of various kinds of portable devices, such as mobile phones and notebook computers, and information electronic devices, such as HDTVs, that implement images of high resolution and high quality, demand for corresponding display devices has been gradually increased. As such display devices, LCDs (Liquid Crystal Displays), PDPs (Plasma Display Panels), FEDs (Field Emission Displays), and OLEDs (Organic Light emitting Diodes) have been actively studied.

The driving frequency of a display device is defined according to the number of images that are refreshed on a screen for one second, and the display device having the driving frequency of 60 Hz displays new images of 60 frames per second. Such screen refresh requires power consumption, and by displaying the screen with the driving frequency that is lower than 60 Hz, the power consumption can be reduced. In the related art, low-frequency driving, which is to drive the display device with a frequency that is lower than 60 Hz with respect to specific images, has been proposed.

In this case, however, flicker may occur due to the frequency change when the driving is changed from high-frequency driving to low-frequency driving. Further, flicker may occur due to a difference in data charging rate when a high-gradation image is displayed through the low-frequency driving.

### SUMMARY OF THE INVENTION

Accordingly, the present invention has been made to solve the above-mentioned problems occurring in the related art, and one subject to be solved by the present invention is to provide a timing controller, which controls flicker that occurs during low-frequency driving to be unrecognizable to a user.

Another subject to be solved by the present invention is to provide a display device, which controls flicker that occurs during low-frequency driving to be unrecognizable to a user.

Still another subject to be solved by the present invention is to provide a method for driving a timing controller, which controls flicker that occurs during low-frequency driving to be unrecognizable to a user.

Additional advantages, subjects, and features of the invention will be set forth in part in the description which follows and in part will become apparent to those having ordinary skill in the art upon examination of the following or may be learned from practice of the invention.

In one aspect of the present invention, there is provided a timing controller comprising a first controller providing a driving frequency change signal for changing a first driving frequency to a second driving frequency that is different from the first driving frequency and a second controller receiving the driving frequency change signal and generating a scan start signal corresponding to the second driving frequency, the second controller outputting a changed scan start signal in response to sensing a blink of an eye of a user.

The second controller outputs the scan start signal having a frequency that corresponds to the eye blink of the user after the first driving frequency is changed to the second driving frequency.

If the frequency of the scan start signal that is generated corresponding to the eye blink is lower than a minimum driving frequency, the second controller changes the scan start signal corresponding to the first driving frequency to output the changed scan start signal.

The first controller generates image data through correction of a gradation value of an image signal according to luminance data provided from a luminance measuring unit.

The second controller outputs the scan start signal when a user's eyelid covers ¾ or more of a pupil of the user's eye.

The first driving frequency is a high frequency, and the second driving frequency is a low frequency.

The high frequency is a frequency that is equal to or higher than 60 Hz, and the low frequency is a frequency that is equal to or lower than 1 Hz.

The second controller is an MCU (Micro Controller Unit).

In another aspect of the present invention, there is provided a display device comprising a display unit having a plurality of pixels arranged in a matrix form and a timing controller controlling the display unit, wherein the timing controller includes: a first controller providing a driving frequency change signal for changing a first driving frequency to a second driving frequency that is different from the first driving frequency; and a second controller receiving the driving frequency change signal and generating a scan start signal corresponding to the second driving frequency, the second controller outputting a changed scan start signal in response to sensing a blink of an eye of a user.

The second controller outputs the scan start signal having a frequency that corresponds to the eye blink of the user after the first driving frequency is changed to the second driving frequency.

If the frequency of the scan start signal that is generated corresponding to the eye blink is lower than a minimum driving frequency, the second controller changes the scan start signal corresponding to the first driving frequency to output the changed scan start signal.

The display device further comprising a luminance measuring unit measuring luminance of the display unit, wherein the first controller generates image data through correction of a gradation value of an image signal according to luminance data provided from a luminance measuring unit.

The second controller outputs the scan start signal when a user's eyelid covers ¾ or more of a pupil of the user's eye.

The second controller is an MCU (Micro Controller Unit).

The display device further comprising a scan driving unit providing a scan signal according to the scan start signal to the display unit and a data driving unit providing a data voltage that is applied to the display unit corresponding to the scan signal.

In another aspect of the present invention, there is provided a method for driving a timing controller, comprising generating a scan start signal corresponding to a second driving frequency which is different from a first driving frequency that is driven in a previous frame, sensing a blink of an eye of a user, and outputting the scan start signal corresponding to the eye blink of the user.

The method for driving a timing controller further comprising generating and outputting the scan start signal having a frequency that corresponds to the eye blink of the user after the outputting the scan start signal corresponding to the second driving frequency.

The method for driving a timing controller further comprising changing the scan start signal corresponding to the first driving frequency and outputting the changed scan start signal if the frequency of the scan start signal that is generated corresponding to the eye blink of the user is lower than a minimum driving frequency.

The method for driving a timing controller further comprising measuring luminance of a display unit after the outputting the scan start signal corresponding to the second driving frequency, and correcting a gradation value of an image signal according to the measured luminance data.

Sensing of the eye blink is performed by an MCU (Micro Controller Unit).

According to embodiments of the present invention, at least the following effects can be achieved.

The flicker that occurs during the frequency change or low-frequency driving can be substantially unrecognizable to the user.

The display quality can be substantially improved with reduced power consumption.

The effects according to the present invention are not limited to the contents as exemplified above, but further various effects are included in the description.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a display device according to an embodiment of the present invention;

FIG. 2 is a schematic diagram explaining a luminance change of a pixel according to a frequency change according to the present invention;

FIG. 3 is a block diagram of a timing controller according to an embodiment of the present invention;

FIG. 4 is a timing diagram according to an embodiment of the present invention;

FIG. 5 is a block diagram of a display device according to another embodiment of the present invention;

FIG. 6 is a block diagram of a timing controller of FIG. 5;

FIG. 7 is a timing diagram according to another embodiment of the present invention; and

FIG. 8 is a flowchart of a method for driving a timing controller according to an embodiment of the present invention.

### DETAILED DESCRIPTION OF THE INVENTION

The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the present invention, the same drawing reference numerals are used for the same elements across various figures.

Although the terms “first, second, third, etc.” are used to describe diverse constituent elements, such constituent elements are not limited by the terms. The terms are used only to discriminate a constituent element from other constituent elements in the specification. The claims may not use the same terms, but instead will use the terms “first, second, third, etc.” with respect to the claimed order. Accordingly, in the following description, a first constituent element may be a second constituent element.

Hereinafter, preferred embodiments of the present invention will be described in detail with reference to the accompanying drawings.

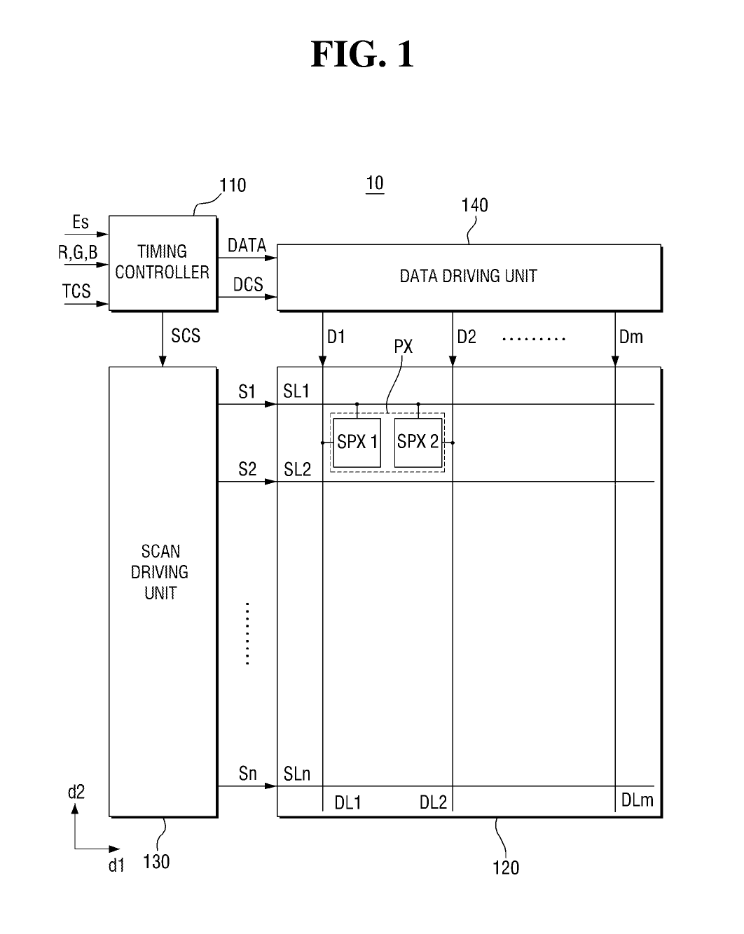

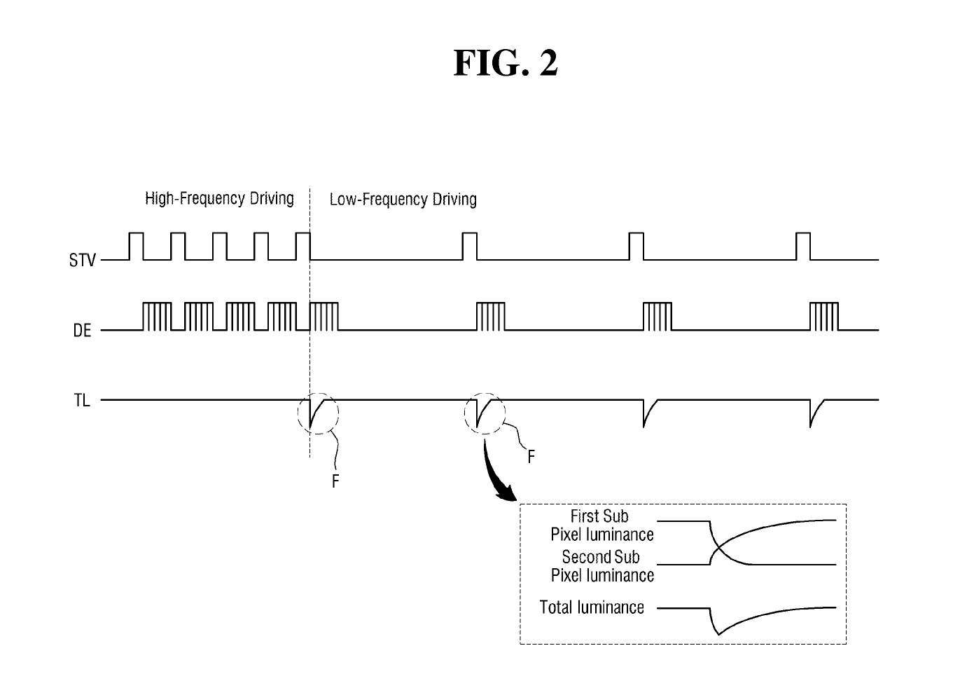

FIG. 1 is a block diagram of a display device according to an embodiment of the present invention, and FIG. 2 is a schematic diagram explaining a luminance change of a pixel according to a frequency change according to the present invention.

Referring to FIGS. 1 and 2, a display device 10 includes a timing controller 110, a display unit 120, a scan driving unit 130, and a data driving unit 140.

The timing controller 110 may receive an input of an image signal RGB and a timing control signal from an outside. Here, the timing control signal TCS may be a vertical sync signal, a horizontal sync signal, a main clock signal, and a data enable signal DE. The timing controller 110 may process the signals to meet the operating conditions of the display unit 120, and then generate image data DATA, a data control signal DCS, and a scan control signal SCS. The data control signal DCS may include a horizontal sync start signal that indicates an input start of the image data DATA and a load signal to apply data voltages D1 to Dm to data lines DL1 to DLm.

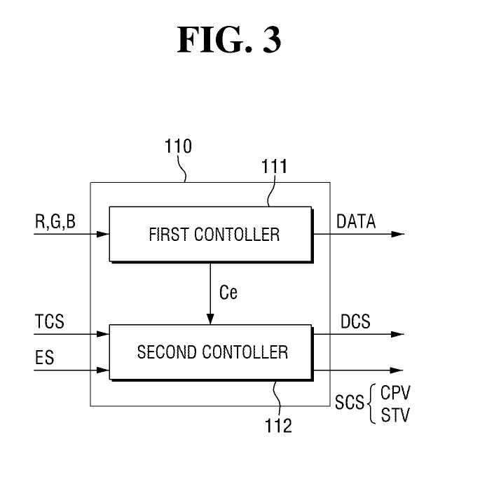

The scan driving unit 130 may receive the scan control signal SCS from the timing controller 110. The scan driving unit 130 may output a plurality of scan signals S1 to Sn to the display unit 120 corresponding to the received scan control signal SCS. The scan control signal SCS may include a scan start signal STV (FIGS. 2 and 3) that indicates an output start of scan signals S1 to Sn to scan lines SL1 to SLn and a gate clock signal CPV (FIG. 3) that controls an output time of a scan-on pulse. The scan-on pulse is a high voltage level of the scan start signal STV of the scan control signal SCS, and a scan-off is a low voltage level of the scan start signal STV of the scan control signal SCS.

The data driving unit 140 may include, but not shown, a shift register, a latch, and a digital-to-analog converter. The data driving unit 140 may receive the data control signal DCS and the image data DATA from the timing controller 110. The data driving unit 140 may select a reference voltage corresponding to the data control signal DCS, and may convert the digital image data DATA into the plurality of data voltages D1 to Dm corresponding to the selected reference voltage. The data driving unit 140 may output the plurality of data voltages D1 to Dm to the display unit 120.

The display unit 120 may be a region on which an image is displayed. The display unit 120 may be any one of an LCD panel, an electrophoretic display panel, an OLED panel, an LED panel, an inorganic EL display panel, a FED panel, a SED panel, a PDP, and a CRT. In the following description, the display unit 120 is described as a liquid crystal display (LCD) panel, but is not limited thereto.

The display unit 120 may include a plurality of scan lines SL1 to SLn, a plurality of data lines DL1 to DLm that cross the plurality of scan lines SL1 to SLn, and a plurality of pixels PX each of which is connected to one of the plurality of scan lines SL1 to SLn and one of the plurality of data lines DL1 to DLm. The plurality of scan lines SL1 to SLn may be shaped to extend in a first direction d1, and may be substantially in parallel to each other. The plurality of scan lines SL1 to SLn may include first to n-th scan lines SL1 to SLn that are arranged in order. The plurality of data lines DL1 to DLm may respectively cross the plurality of scan lines SL1 to SLn. That is, the plurality of data lines DL1 to DLm may be shaped to extend in a second direction d2 that is perpendicular to the first direction d1, and may be substantially in parallel to each other. Here, the first direction d1 may correspond to a row direction, and the second direction d2 may correspond to a column direction. Data voltages D1 to Dm may be applied to the plurality of data lines DL1 to DLm. The plurality of pixels PX may be arranged in a matrix form, but are not limited thereto. Each of the plurality of pixels PX may be connected to one of the plurality of scan lines SL1 to SLn and one of the plurality of data lines DL1 to DLm. The plurality of pixels PX may receive the data voltages D1 to Dm that are applied to the connected data lines DL1 to DLm corresponding to scan signals S1 to Sn provided from the connected scan lines SL1 to SLn.

Here, the timing controller 110 may change the driving frequency of the display unit 120 to output the changed driving frequency. The driving frequency corresponds to the number of images that are refreshed per second, and this may correspond to the output timing of the scan start signal STV. That is, the timing controller 110 can control the driving frequency of the display unit 120 through controlling of the scan start signal STV. In this case, however, as illustrated in FIG. 2, temporary luminance deterioration may occur due to the change from high-frequency driving to low-frequency driving. That is, flicker F may occur to deteriorate the display quality.

Further, each pixel of the display panel 120 may include a first sub-pixel SPX1 and a second sub-pixel SPX2. The first sub-pixel SPX1 and the second sub-pixel SPX2 may be provided through spatial division of the pixel PX. A first data voltage D1 of a first gradation may be applied to the first sub-pixel SPX1, and a second data voltage D2 of a second gradation may be applied to the second sub-pixel SPX2. The first gradation and the second gradation are different from each other, and the gradation of an image that is to be displayed by each pixel PX can be completed through a sum of the first gradation and the second gradation. That is, the first gradation may be a gradation that is relatively closer to 0 gray, and the second gradation may be a gradation that is relatively closer to 255 gray.

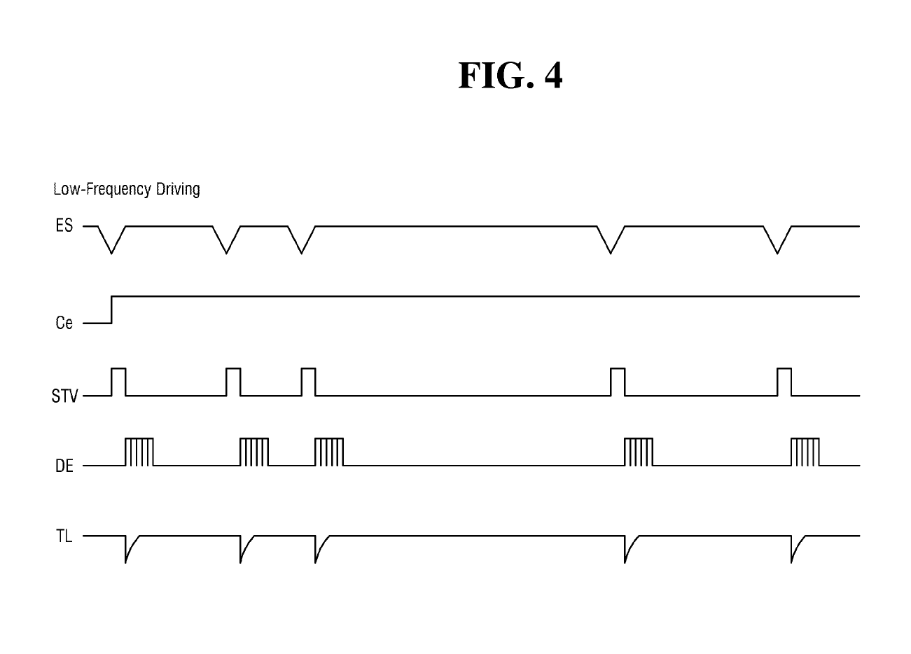

The data voltage charging rate from high gradation to low gradation may be different from the data voltage charging rate from low gradation to high gradation. Accordingly, as illustrated in FIG. 2, the total luminance TL of the pixel PX may temporarily appear to be lower than the predetermined luminance. That is, the flicker F may occur to deteriorate the display quality. The flicker F due to the data voltage charging rate may occur more frequently during the low-frequency driving having long refresh period. However, the timing controller 110 of the display device 10 according to this embodiment may operate to output the scan start signal STV corresponding to a blink of an eye of a user so that the flicker F is not substantially recognized. Hereinafter, this will be described in more detail with reference to FIGS. 3 and 4.

FIG. 3 is a block diagram of a timing controller according to an embodiment of the present invention, and FIG. 4 is a timing diagram according to an embodiment of the present invention.

Referring to FIGS. 3 and 4, the timing controller 110 may include a first controller 111 and a second controller 112.

The first controller 111 may process an input image signal RGB and generate image data DATA. Further, the first controller 111 may determine whether the driving frequency of the display unit 110 has been changed. Exemplarily, the first controller 111 can determine whether the currently input image signal RGB corresponds to a still image or a moving image through comparison of the input image signal with the image signal of a previous frame. If the input image signal RGB corresponds to a still image, the first controller 111 may determine to change the driving frequency to low frequency in order to reduce power consumption, while if the input image signal RGB corresponds to a moving image, the first controller 111 may determine to change the driving frequency to high frequency. However, cases where the first controller 111 determines that the change of the driving frequency is necessary are not limited thereto.

If it is necessary to change the driving frequency, the first controller 111 may provide a driving frequency change signal Ce for changing the current driving frequency to the second controller 112. The driving frequency change signal Ce may be a signal for changing the high-frequency driving to the low-frequency driving, or for changing the low-frequency driving to the high-frequency driving. Here, the high frequency may be a frequency that is equal to or higher than 60 Hz, and the low frequency may be a frequency that is equal to or lower than 1 Hz, but are not limited thereto. Hereinafter, a case where the driving frequency is changed from the high-frequency driving to the low-frequency driving will be described. However, even in the opposite case, the similar description may be made.

The second controller 112 may receive the driving frequency change signal Ce from the first controller 111 and may receive an eye blink sensing signal ES from an outside. The second controller 112 may generate the scan start signal STV corresponding to the driving frequency change signal Ce. That is, the second controller 112 may generate the scan start signal STV corresponding to the low-frequency driving. Here, if a blink of an eye of a user is sensed, the second controller 112 may output the scan start signal STV to the scan driving unit 130. That is, the eye blink sensing signal ES may be a signal that is provided from an external sensor (not illustrated) that observes the user's eye. The external sensor (not illustrated) may continuously scan the user's eye with a frequency that is at least higher than the low frequency and may provide scanned image data to the second controller 112 as the eye blink sensing signal ES. The second controller 112 may determine whether the user blinks his/her eye through a ratio in which the user's eyelid covers the pupil of the eye. In an exemplary embodiment, the second controller 112 may determine the eye blink if the eyelid covers ¾ or more of the pupil. If the eye blink is determined, the second controller may output the scan start signal STV to the scan driving unit 130.

That is, the display device 10 according to an embodiment of the present invention may change the frequency from the high frequency to the low frequency in a state where the user blinks his/her eye. Accordingly, the flicker F that occurs when the frequency is changed from the high frequency to the low frequency may not be substantially recognized by the user.

After the frequency is changed to the low frequency, the second controller 112 may output the scan start signal STV having a frequency corresponding to the eye blink of the user. That is, the scan start signal STV from the next frame after the scan start signal STV that corresponds to the low frequency is output may be formed in a period that corresponds to the eye blink of the user. The external sensor (not illustrated) may scan the user's eye with a frequency that is at least higher than the low frequency and may provide the scanned image data to the second controller 112 as the eye blink sensing signal ES.

Here, FIG. 4 is an exemplary timing diagram, and the eye blink sensing signal ES illustrated in FIG. 4 may be a signal that is recognized as eye blink. As the frequency is changed to the low frequency, a mode, in which the second controller 112 generates the scan start signal STV with the frequency that corresponds to the eye blink, may be activated. That is, the second controller 112 may generate the scan start signal STV corresponding to the eye blink sensing signal ES when a driving frequency change signal Ce is activated, and may output the scan start signal STV to the scan driving unit 130. Exemplarily, the second controller 112 may output the scan start signal STV when the user's eyelid covers ¾ or more of the pupil. That is, since the timing controller 110 of the display device 10 according to this embodiment can output the scan start signal STV corresponding to the eye blink of the user during the low-frequency driving, temporary flicker F that occurs due to charging of the non-uniform data voltage may not be substantially recognized by the user's eye. Accordingly, substantial display quality can be improved with reduced power consumption.

Here, the second controller 112 may be an MCU (Micro Controller Unit) that performs determination of the eye blink without passing through an AP (Application Processor). That is, since the second controller 112 is configured as the MCU, transmission time that is required for transmission to the AP (Application Processor) can be shortened. That is, the timing controller 110 according to this embodiment can provide rapid data processing.

Hereinafter, a display device 20 according to another embodiment of the present invention will be described. In the following description, explanation of the same configuration as the above-described configuration will be omitted or simplified, and explanation will be made around different points between them.

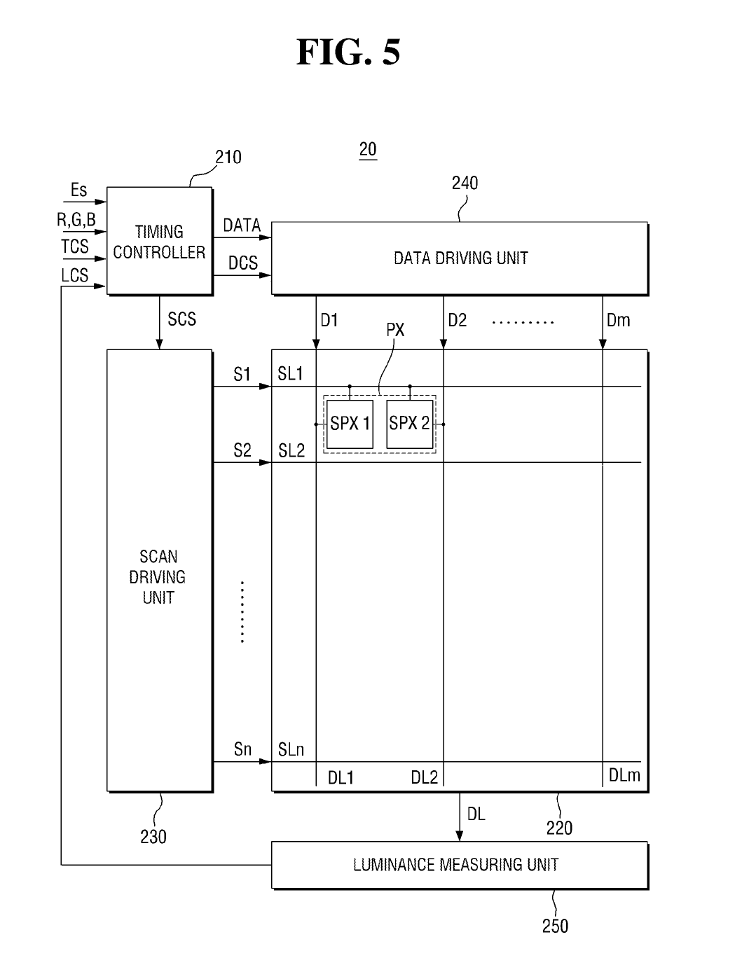

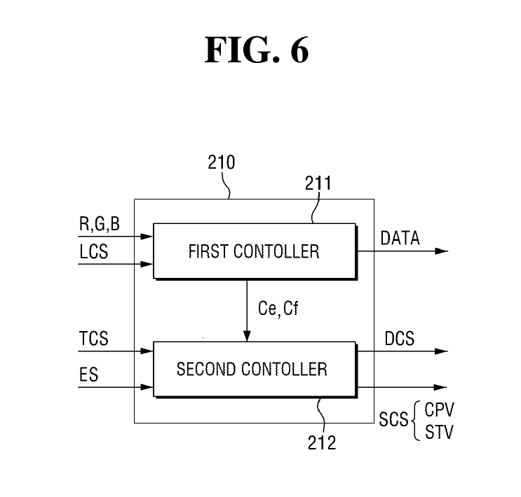

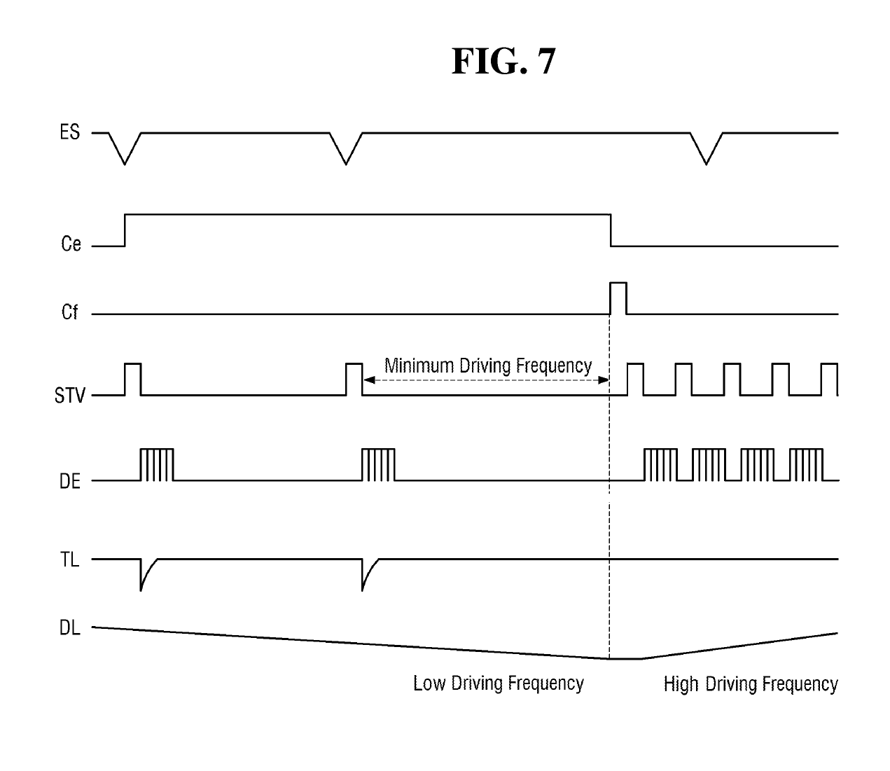

FIG. 5 is a block diagram of a display device according to another embodiment of the present invention, and FIG. 6 is a block diagram of a timing controller of FIG. 5. FIG. 7 is a timing diagram according to another embodiment of the present invention.

Referring to FIGS. 5 to 7, a display device 20 includes a timing controller 210, a display unit 220, a scan driving unit 230, and a data driving unit 240.

A timing controller 210 of a display device according to this embodiment may determine whether the frequency of a scan start signal STV that is generated corresponding to eye blink is lower than the minimum driving frequency. Here, the minimum driving frequency may be a refresh period that is required to prevent a data voltage applied to a display unit 220 from being discharged. Exemplarily, the minimum driving frequency may be 0.1 Hz, but is not limited thereto. That is, if the frequency of the eye blink of a user is very low frequency when the scan start signal STV is generated corresponding to the eye blink of the user in a low-frequency driving mode, the luminance of the display unit 220 may be decreased due to the discharge of the data voltage as described above. If the frequency of an input eye blink sensing signal ES is lower than the minimum driving frequency, a second controller 212 of the timing controller 210 releases an eye blink sensing mode to compensate for the luminance generated accordingly, and may generate a signal Cf for changing the driving frequency. In this case, the changed frequency may be high frequency that is equal to or higher than 60 Hz.

The display device 20 according to this embodiment may further include a luminance measuring unit 250. The luminance measuring unit 250 may measure the total luminance DL of the display unit 220. The luminance measuring unit 250 may be a photo sensor, but is not limited thereto. The luminance measuring unit 250 may measure the total luminance DL of the display unit 220 based on a unit frame. The luminance measuring unit 250 may measure the luminance change of the display unit 220 during the low-frequency driving through sensing of the eye blink, and may provide measured luminance data LCS to the timing controller 210.

A first controller 211 of the timing controller 210 may correct the gradation value of an input image signal RGB according to the provided luminance data LCS to output the corrected image data DATA. The above-described correction may be a correction to heighten the gradation value set in the input image signal RGB. That is, the display device 20 according to this embodiment may measure the luminance of the display unit 220 that may be decreased due to the low-frequency driving, and may correct the decreased luminance through heightening of the gradation value of the image data DATA.

Since other remaining configurations of the display device 20 according to this embodiment are substantially the same as the configurations of the display device 10 of FIGS. 1 to 4 having the same names, the explanation thereof will be omitted.

Hereinafter, a method for driving a timing controller according to an embodiment of the present invention will be described.

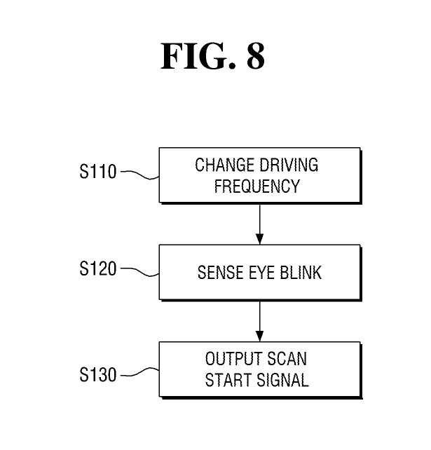

FIG. 8 is a flowchart of a method for driving a timing controller according to an embodiment of the present invention. For more detailed explanation, FIGS. 1 to 7 may be referred to.

Referring to FIG. 8, a method for driving a timing controller according to an embodiment of the present invention includes changing a driving frequency (S110), sensing eye blink (S120), and outputting a scan start signal (S130).

First, the driving frequency is changed (S110).

The timing controller according to this embodiment may be in a state where it is driven by a first driving frequency at a previous frame. Here, the timing controller may determine whether the driving frequency has been changed. Exemplarily, the timing controller can determine whether the currently input image signal RGB corresponds to a still image or a moving image through comparison of the input image signal with the image signal of the previous frame. If the input image signal corresponds to a still image, the timing controller may determine to change the driving frequency to low frequency in order to reduce power consumption, while if the input image signal corresponds to a moving image, the timing controller may determine to change the driving frequency to high frequency. However, methods in which the timing controller determines that the change of the driving frequency is necessary are not limited thereto. The timing controller may determine to change the driving frequency to a second driving frequency that is different from the first driving frequency and may generate the scan start signal corresponding to the second driving frequency.

Then, a blink of an eye of a user is sensed (S120).

An external sensor (not illustrated) may scan the user's eye and provide scanned image data to the timing controller as an eye blink sensing signal. The timing controller may determine whether the user blinks his/her eye through analysis of the eye blink sensing signal. The timing controller may determine whether the user blinks his/her eye through a ratio in which the user's eyelid covers the pupil of the eye. In an exemplary embodiment, the timing controller may determine the eye blink if the eyelid covers ¾ or more of the pupil. However, the method for determining the eye blink is not limited thereto.

Last, the scan start signal is output (S130).

The timing controller may output the scan start signal that corresponds to the second driving frequency in response to the eye blink. That is, the timing controller may output the scan start signal, included in the scan control signal, that corresponds to the generated second driving frequency simultaneously with determination of the eye blink. Accordingly, flicker that occurs due to the frequency change may not be substantially recognized by the user.

As shown in FIG. 7, each time an eye blink is sensed (ES) the scan-start signal STV is output during the low frequency driving period corresponding to, for example, the display of a still image. When the driving frequency change signal Ce is generated due to, for example, a change from a still image to a moving image, the scan-start signal STV is generated according to timing control signals TCS input to timing controller 210, and the scan-start signal STV is not affected by the detection of an eye blink.

The timing controller may include an MCU (Micro Controller Unit). The determination of the eye blink may be performed by the MCU without passing through an AP (Application Processor). That is, since the MCU performs the above-described operation, the transmission time that is required for transmission to the AP (Application Processor) can be shortened. That is, the driving method according to this embodiment can provide rapid data processing.

In some embodiments, the method for driving a timing controller may further include generating and outputting the scan start signal having a frequency that corresponds to the eye blink of the user after outputting the scan start signal that corresponds to the second driving frequency. That is, the scan start signal from the next frame after the scan start signal that corresponds to the low frequency is output may be formed in a period that corresponds to the eye blink of the user. Accordingly, during the low-frequency driving, flicker that may occur due to the charging of the non-uniform data voltage may not be substantially recognized by the user's eye. Accordingly, substantial display quality can be improved with reduced power consumption.

Further, if the frequency of the scan start signal is lower than the minimum driving frequency, the luminance of the display unit may deteriorate. According to the driving method according to some embodiments, if the frequency of the scan start signal that is generated corresponding to the eye blink of the user is lower than the minimum driving frequency, the scan start signal may be changed corresponding to the first driving frequency to be output. That is, the deteriorated luminance can be heightened by performing the high-frequency driving again.

Further, according to the driving method according to some embodiments, in the above-described case, the decreased luminance can be compensated for through heightening of the data gradation.

Other explanations of the method for driving a timing controller are substantially the same as those of the display device of FIGS. 1 to 8, and thus the detailed explanation thereof will be omitted.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A timing controller comprising:
a first controller providing a driving frequency change signal for changing a first driving frequency to a second driving frequency that is different from the first driving frequency; and
a second controller receiving the driving frequency change signal and generating a scan start signal corresponding to the second driving frequency, the second controller outputting a changed scan start signal in response to sensing a blink of an eye of a user.

2. The timing controller of claim 1, wherein the second controller outputs the changed scan start signal having a frequency that corresponds to the eye blink of the user after the first driving frequency is changed to the second driving frequency.

3. The timing controller of claim 2, wherein if the frequency of the scan start signal that is generated corresponding to the eye blink is lower than a minimum driving frequency, the second controller changes the scan start signal corresponding to the first driving frequency to output the changed scan start signal.

4. The timing controller of claim 2, wherein the first controller generates image data through correction of a gradation value of an image signal according to luminance data provided from a luminance measuring unit.

5. The timing controller of claim 1, wherein the second controller outputs the scan start signal when a user's eyelid covers ¾ or more of a pupil of the user's eye.

6. The timing controller of claim 1, wherein the first driving frequency is a high frequency, and the second driving frequency is a low frequency.

7. The timing controller of claim 6, wherein the high frequency is a frequency that is equal to or higher than 60 Hz, and the low frequency is a frequency that is equal to or lower than 1 Hz.

8. The timing controller of claim 1, wherein the second controller is a micro controller unit (MCU).

9. A display device comprising:
a display unit having a plurality of pixels arranged in a matrix form; and
a timing controller controlling the display unit,
wherein the timing controller includes:
a first controller providing a driving frequency change signal for changing a first driving frequency to a second driving frequency that is different from the first driving frequency; and
a second controller receiving the driving frequency change signal and generating a scan start signal corresponding to the second driving frequency, the second controller outputting a changed scan start signal in response to sensing a blink of an eye of a user.

10. The display device of claim 9, wherein the second controller outputs the scan start signal having a frequency that corresponds to the eye blink of the user after the first driving frequency is changed to the second driving frequency.

11. The display device of claim 10, wherein if the frequency of the scan start signal that is generated corresponding to the eye blink is lower than a minimum driving frequency, the second controller changes the scan start signal corresponding to the first driving frequency to output the changed scan start signal.

12. The display device of claim 2, further comprising a luminance measuring unit measuring luminance of the display unit,
wherein the first controller generates image data through correction of a gradation value of an image signal according to luminance data provided from a luminance measuring unit.

13. The display device of claim 9, wherein the second controller outputs the scan start signal when a user's eyelid covers ¾ or more of a pupil of the user's eye.

14. The display device of claim 9, wherein the second controller is a micro controller unit (MCU).

15. The display device of claim 9, further comprising:
a scan driving unit providing a scan signal according to the scan start signal to the display unit; and
a data driving unit providing a data voltage that is applied to the display unit corresponding to the scan signal.

16. A method for driving a timing controller, comprising:
generating a scan start signal corresponding to a second driving frequency which is different from a first driving frequency that is driven in a previous frame;
sensing a blink of an eye of a user; and
outputting the scan start signal corresponding to the eye blink of the user.

17. The method of claim 16, further comprising generating and outputting the scan start signal having a frequency that corresponds to the eye blink of the user after the outputting the scan start signal corresponding to the second driving frequency.

18. The method of claim 17, further comprising changing the scan start signal corresponding to the first driving frequency and outputting the changed scan start signal if the frequency of the scan start signal that is generated corresponding to the eye blink of the user is lower than a minimum driving frequency.

19. The method of claim 16, further comprising measuring luminance of a display unit after the outputting the scan start signal corresponding to the second driving frequency, and correcting a gradation value of an image signal according to the measured luminance data.

20. The method of claim 16, wherein sensing of the eye blink is performed by a micro controller unit (MCU).
